(19) United States
(12) Patent Application Publication
(10) Pub. No.: US 2010/0076830 A1
(43) Pub. Date: Mar. 25, 2010

(54) MEANS FOR COLLECTING, SOLICITING, AND REMUNERATING MEMBERS OF A MULTI-LEVEL MARKETING BUSINESS STRUCTURE

(76) Inventors: Mitch Huhem, San Diego, CA (US); Adam Galland, San Clemente, CA (US); York Galland, Provo, UT (US)

Correspondence Address: Steven L. Rinehart, 1059 E. Millstream Way, Bountiful, UT, 84010, US

(21) Appl. No.: 12/236,497

(22) Filed: Sep. 23, 2008

(51) Int. Cl. G06Q 30/00; G06F 17/30; G06F 15/16; G06Q 10/00

(52) U.S. Cl. 705/14.16; 705/26; 709/204; 705/30

(57) ABSTRACT

An apparatus, method, computer program product and system are disclosed for collecting, soliciting and tracking sales leads via an electronic network like the Internet, and distributing commissions realized on said sales leads to multiple parties using a hierarchical, multi-level marketing (MLM) business structure. A central managing organization, or MLM structure, uses a uniquely configured data processing device and/or system (herein a “Maintenance Server”) to collect new sales leads from structured records and data in the possession of an actual customers who have been incorporated into the MLM structure, said records and data comprising third-party contact information, including personal and/or professional contacts of the actual customers. The Maintenance Server uniquely assists in the solicitation of the newly acquired sales leads to save the actual customers from having to perform the solicitation(s) themselves. Sales leads converted into actual customers are incorporated into the MLM structure and the newly generated commissions resulting therefrom are distributed by the Maintenance Server or MLM structure in accordance with a predetermined commission criteria.

### BACKGROUND OF THE INVENTION

1. Field of the Invention

This invention relates to multi-level marketing, and more particularly relates to an apparatus, method, computer program product and data processing system for collecting, soliciting, tracking and distributing commissions within a hierarchical multi-level marketing business structure.

2. Description of the Related Art

Consumer products are often sold and shipped within multi-level marketing (MLM) hierarchical business structures (hereinafter the “MLM structures”) that remunerate members of the MLM structures responsible for the sale of consumer products as well as certain members of the MLM structures responsible for bringing other member(s) into the MLM structure. Companies adopting MLM structures allow their members to profit not just from sales those members effectuate, but also from sales effectuated by newer members brought into the MLM structure by older members.

MLM structures organize their members into hierarchical pay grades, or levels, and distribute commissions made on the sale of consumer products by trickling the commissions up to members in higher levels, particularly those members who were responsible for the incorporation of the members responsible for making sales.

Often MLM structures will provide their members with printed instructions and/or training in methods of both selling consumer products and recruiting others into the MLM structure. Typical methods of recruiting others include conferences in which potential members, and contacts of members, are given the opportunity to socialize with experienced members, experience multimedia presentations of various species, hear testimonials of successful members, and become acquainted with the particular implementation of the MLM structure assumed by the company or organization distributing the one or more consumer product(s) underlying the MLM structure.

Many companies implementing MLM structures have enjoyed remarkable success in years past, but other MLM companies have struggled due to the inability and/or reluctance of many members, and potential members, to participate in the MLM marketing programs. Many members and potential members are hesitant to recruit their personal and professional contacts into the MLM structure. Members may lack the ability to successfully recruit their contacts, or may be disinclined to strain relationships they have established with their contacts by subjecting those contacts to the rhetoric necessary to successfully recruit them. These members may be similarly disinclined to solicit sales of the consumer product(s) marketed by the MLM structure from their personal and professional contacts.

Many members of MLM structures come to exist in name only, without realizing new member recruits or producing consumer product sales. These members may discontinue or dishonor obligations incidental to their membership in the MLM structure, such as membership fees or obligations to purchase MLM products. These problems inherent in traditional MLM structures have caused MLM structures to suffer low member retention rates, inefficient new member recruitment drives, and unproductive solicitation of new sales from member contacts.

### SUMMARY OF THE INVENTION

From the foregoing discussion, it should be apparent that a need exists for a system, apparatus, method, and computer program product for soliciting, managing, and remunerating potential MLM members and customers. The present invention has been developed in response to the present state of the art; and, in particular, in response to the problems and needs in the art that have not yet been fully solved by currently available methods, systems and apparatus, and that overcome many or all of the above-discussed shortcomings in the art. Accordingly, the present invention has been developed to provide an apparatus, method, computer program product, and system for collecting, soliciting and tracking sales leads via an electronic network like the Internet, and distributing commissions realized on said sales leads to multiple parties using a hierarchical MLM business structure.

A computer program product is disclosed comprising a computer readable medium having computer usable program code executable to perform operations for automatically collecting, soliciting and remunerating members of an MLM structure. The operations of the computer program product include incorporating a customer into an MLM structure by storing one or more of the customer's name, email, address, and phone number in persistent computer readable storage; and electronically accessing identifying information of one or more third-party contacts (hereinafter the “contact information”) in possession of the customer via a computer network, said contact information accessible only through a grant of permission of from the customer, said contact information structured in one or more computer readable files and comprising one or more of name, address, email, telephone number, employer, and profession.

The operations of the computer program product further include storing the contact information on a tangible medium after electronically accessing the third-party contact information; and transmitting the contact information to one or more solicitors. The operations further include using an MLM identifier to track the customer with whom the contact information originated. The computer program product further comprises, in some embodiments, remunerating the customer for sales realized from the third-party contacts.

The customer may be remunerated in accordance with a predetermined commission criteria, and the computer program product may further comprise emailing the third-party contacts with MLM promotional information. Additionally, the computer program product comprises, in some embodiments, automatically incorporating the third-party contacts into the MLM structure.

The computer program product further comprises notifying the customer that the one or more third-party contacts have been incorporated into the MLM structure, and the contact information can comprise a computer database entry stored in one or more computer readable files on a computer readable storage device in communication with a maintenance server. The maintenance server may allow the third-party contacts to place orders for a consumer product online via the Internet.

An apparatus is disclosed, comprising a database server, processor, and a memory device, which apparatus is configured to perform operations that closely mirror the functions imparted to a computer by the computer program product.

Additionally, a system to automatically collect, solicit and remunerate members of an MLM structure is disclosed which comprises modules functionally similar to those of the apparatus. A business method is disclosed for collecting, soliciting and remunerating members of an MLM structure.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1A is a block diagram illustrating one embodiment of a computer system that automatically collects, solicits and remunerates members of a MLM structure in accordance with the present invention;

FIG. 1B is a block diagram illustrating an MLM structure that collects, solicits, and remunerates members of a MLM structure in accordance with the present invention;

FIG. 2 is a schematic block diagram illustrating one embodiment of an apparatus to automatically collect, solicit and remunerate MLM members in accordance with the present invention;

FIG. 3 is a diagram illustrating one embodiment of a sales campaign comprising customer contact information structured within a computer readable file;

FIG. 4 is a block diagram illustrating another embodiment of an MLM business structure in accordance with the present invention;

FIG. 5 is a block diagram illustrating another embodiment of a computer system that automatically collects, solicits and remunerates members of a MLM structure in accordance with the present invention;

FIG. 6 is a data flow chart of a method of collecting, soliciting and remunerating members of a MLM structure in accordance with the present invention;

FIG. 7 is a process flow chart of a method of automatically collecting, soliciting and remunerating members of a MLM structure in accordance with the present invention;

FIG. 8 is a business element framework that defines one embodiment of an MLM structure in accordance with the present invention; and

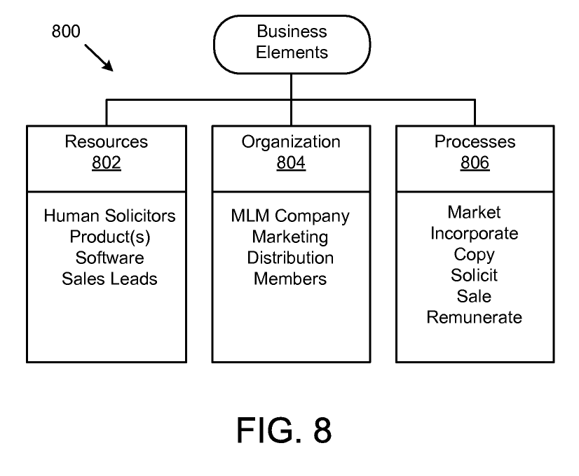

FIG. 9 is a user screen in a generic browser showing cost information associated with a plurality of sales leads in accordance with the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. In the following description, numerous specific details are provided. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention. The apparatus modules recited in the claims may be configured to impart the recited functionality to the apparatus.

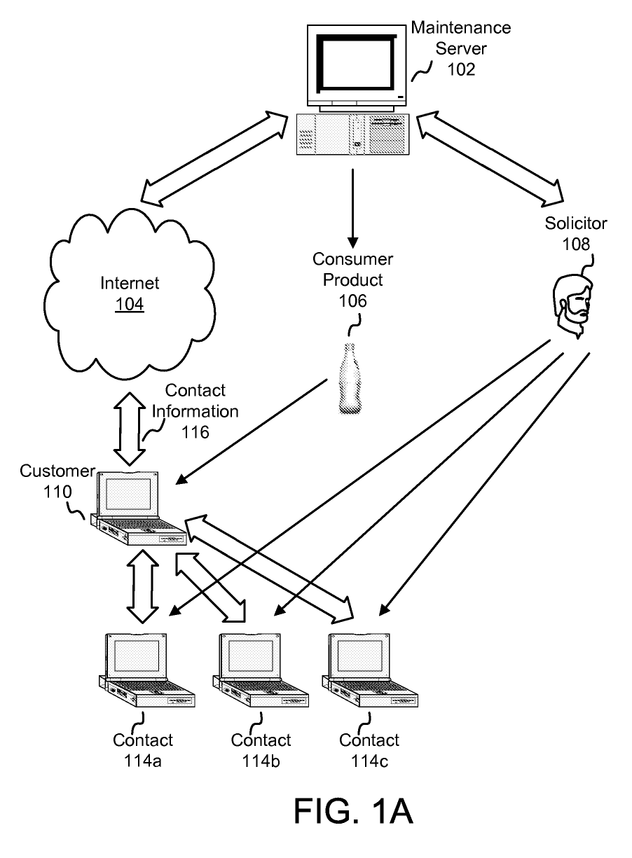

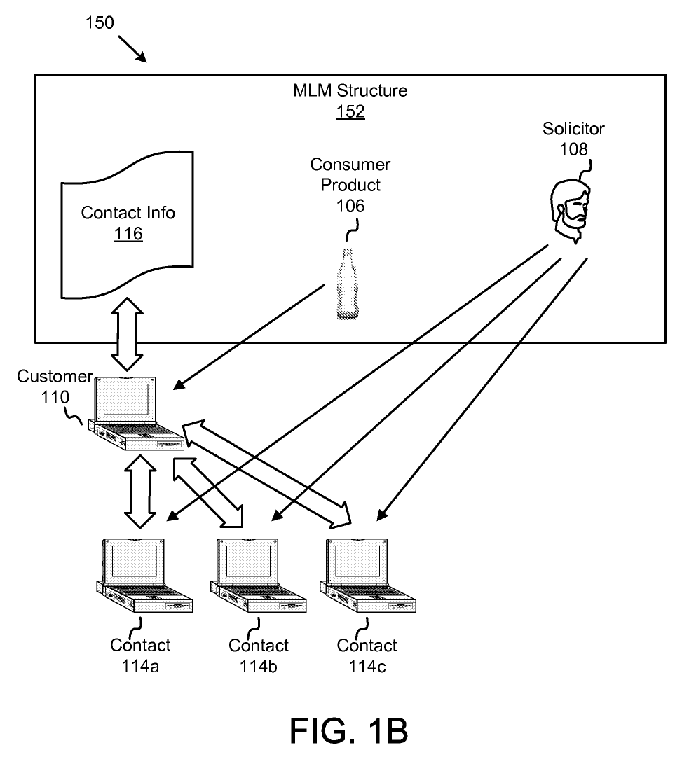

FIG. 1 is a block diagram illustrating one embodiment of a computer system 100 that automatically collects, solicits and remunerates members of a MLM structure in accordance with the present invention. The computer system 100 comprises a maintenance server 102, an Internet 104, a consumer product 106, a solicitor 108, a customer 110 a contact 114a, a contact 114b, and a contact 114c.

The system 100 includes a maintenance server 102. In the shown embodiment, the maintenance server 102 comprises a computer program running on one or more data processing devices (DPDs), such as a server, computer workstation, router, mainframe computer, or the like. In various embodiments, the DPD comprises one or more processors. The processor is a computing device well-known to those in the art and may include an application-specific integrated circuit (“ASIC”).

In the present invention, the maintenance server 102 may route contact information 116 to any DPD, device, person, company, organization, or the like in communication with the maintenance server 102, including the solicitor 108.

In this embodiment, the maintenance server 102 communicates contact information 116 gathered from the customer 110 electronically to the solicitor 108. In other embodiments, the solicitor 108 accesses the contact information 116 from the maintenance server 102 over a distributed network to which the solicitor 108 and maintenance server 102 are mutually coupled. In various embodiments, a plurality of customers 110 incorporated into an MLM structure may be in logical communication with the maintenance server 102 through a networked environment, such as local area network (LAN) or wide area network (WAN), or the Internet 104.

In various embodiments, the maintenance server 102 may make available sales information to customers 110 and/or solicitors 108. In various embodiments the sales information may comprise commissions paid, or to be paid, to the customer(s) 110 on sales realized as a result of the solicitation of one or more contacts 114a-c. In still further embodiments, the maintenance server 102 may automatically make commission payments to customers 110 incorporated into the MLM structure via means well-known to those of skill in the art, including PayPal®, credit card credits, direct bank deposits, and the like. Commission payments to customers 110 may be made in accordance with a predetermined MLM criteria. In some embodiments, the predetermined MLM criteria is dynamic, and optimized automatically through analysis of historical MLM sales data to maximize profits to the MLM structure and/or MLM members.

In the shown embodiment, the maintenance server 102 interacts electronically with the customer 110 via the Internet 104 and offers the customer 110 a free consumer product 106 in exchange for the customer 110 providing, or allowing, access by the maintenance server 102 to, contact information 116 identifying contacts 114a-c associated with the customer 110, the contact information 116 in the possession of the customer 110 in volatile or persistent computer readable storage. The identifying information 116 may comprise contact information useful in emailing the contacts 114a-c via email using variations of the Simple Mail Transfer Protocol (SMTP), Internet Message Access Protocol (IMAP), Post Office Protocol (POP), or other protocols well-known to those of skill in the art. The maintenance server 102 replicates the contact information 116 into computer readable storage to which the MLM structure has exclusive access.

The system 100 includes an Internet 104, well-known to those of skill in the art. The Internet 104 may comprise any collection of interconnected computers and computer networks linked by ethernet cables, wireless connections, and the like, such as the world-wide-web.

The consumer product 106 may comprise any valuable item which can be purchased, tangible or intangible. Examples of consumer products 106 may include fruit drinks, vitamins, cleaners, cars, computers, tools, and the like. The consumer product 106 may be intangible, and comprise video, audio, digit text files, or the like.

The system 100 includes a solicitor 108. The solicitor 108 may comprise a DPD, a company or organization which solicits customers 110, an individual, or any combination of the above. In the shown embodiment, the solicitor 108 comprises a DPD controlled by an MLM structure interested in soliciting potential MLM members and/or customers 110. In some embodiments, the solicitor 108 is configured to interact with a customer 110 through a graphical user interface (GUI) coupled to a DPD or the maintenance server 102. The solicitor 108 is configured to retrieve and/or receive the contact information 116 from, or through, the maintenance server 102. In some embodiments, the solicitor 108 may be configured to receive the contact information 116 as an email attachment using variations of the Simple Mail Transfer Protocol (SMTP), Internet Message Access Protocol (IMAP), Post Office Protocol (POP), or other protocols well-known to those of skill in the art.

In some embodiments, the solicitor 108 in communication with the maintenance server 102 may be assigned a unique identifier used to track the solicitor's 108 efficiency and/or the solicitor's 108 success soliciting new customers 110 and/or effectuating new sales.

The solicitor 108 contacts the potential customer 102 by phone, email, facsimile or the like. The solicitor 108, in alternative embodiments, may comprise an auto-emailer. The solicitor 108 may be internal or external to the maintenance server 102. By transferring solicitation duties from the customer 110 to the solicitor 108 that would normally be incumbent upon the customer 110 to receive financial remuneration by the MLM structure, the present invention overcomes weaknesses in the prior art that limit the efficiency of traditional MLM structures through the automated process herein disclosed which modifies the traditional MLM structure.

The customer 110 may be any person, company or organization that is potentially a customer of another person, company or organization. A customer 110 may purchase one or more consumer products 106 and become “incorporated” into an MLM structure, or the customer 110 may purchase the consumer product 106 and not become incorporated. For the purposes of this patent, the terms “incorporate” and “incorporation” denote the act of formally enrolling an individual or organization into an MLM structure such that the individual or organization receives commissions on down stream sales (sales realized as a result of the efforts of contacts of the individual or organization which are later incorporated), through a mutually recognized business relationship with the MLM structure.

For the purposes of this patent, the term “MLM structure” denotes a multi-level marketing business structure that incorporates its members in hierarchical pay grades, or levels, and remunerates commissions to members in higher levels for the sales of consumer products 106 realized by members in lower levels whom have been incorporated into the MLM structure as a result of the efforts of members in the higher levels. MLM structures are well-known to those of skill in the art.

The contact information 116, in this embodiment, comprises information about the contacts 114a-c with whom the customer 110 associates. The contact information 116, in this embodiment, comprises a computer readable file transmittable over a signal bearing medium like the Internet 104 and storable on a computer readable storage. The contact information 116 may also comprise information about individuals and organizations not associated with the customer 110 but in the customer's 110 possession on computer readable storage. The contact information 116 may include one or more of: age, address, gender, credit rating, email, telephone number, income, education, and purchasing practices. In typical embodiments, the contact information 116 is stored in customer-side email databases by programs well-known to those of skill in the art, such Microsoft Outlook, Thunderbird, Yahoo! Mail, and the like.

The contacts 114a-c are individuals or organizations like the customer 110 whose identifying information is stored on a customer's 110 computer readable storage and who have not yet purchased a consumer product 106 from the MLM structure or been incorporated by the MLM structure. Contacts 114a-c may be solicited after their identifying information is received by the maintenance server 102 after the customer 110 is solicited through any number of processes well-known to those of skill in the art, including through cost-per-click (CPC) advertising or cost-per-impression (CPI) advertising on the Internet 112, through automated telephonic communications initiated by the solicitor 108 or another party, direct mailers, and the like. In the preferred embodiment the solicitor 108 automatically emails the contacts 114a-c.

The system 100 may comprise a cumulative cost indicator. The cumulative cost indicator keeps a running tally of the costs incurred in generating and/or soliciting the one or more contacts 114a-c. In the some embodiments, the cumulative cost indicator may comprise an array of cumulative cost indicators for tracking costs of a plurality of contacts 114a-c.

Referring now to FIG. 1B, a block diagram illustrating an MLM structure that collects, solicits, and remunerates members of a MLM structure in accordance with the present invention. Unlike FIG. 1A, FIG. 1B presents an embodiment of the present invention that is not entirely automated within a computer system. Some, or all, functions of the system 150 may be manually performed by one or more individuals associated with the MLM structure 152 and/or one or more customers 110.

In FIG. 1B, the process of collecting the contact information 116 is substantially the same as FIG. 1A but the contact information is stored on a tangible medium that is not necessarily computer readable, and the storage may effectuated by an incorporated MLM member, or human being, within the MLM structure 152. The consumer product 106 may be shipped manually by a human being, and the solicitation performed by the solicitor 108 may also be non-automated.

The MLM structure 152 is substantially described above in relation to FIG. 1A.

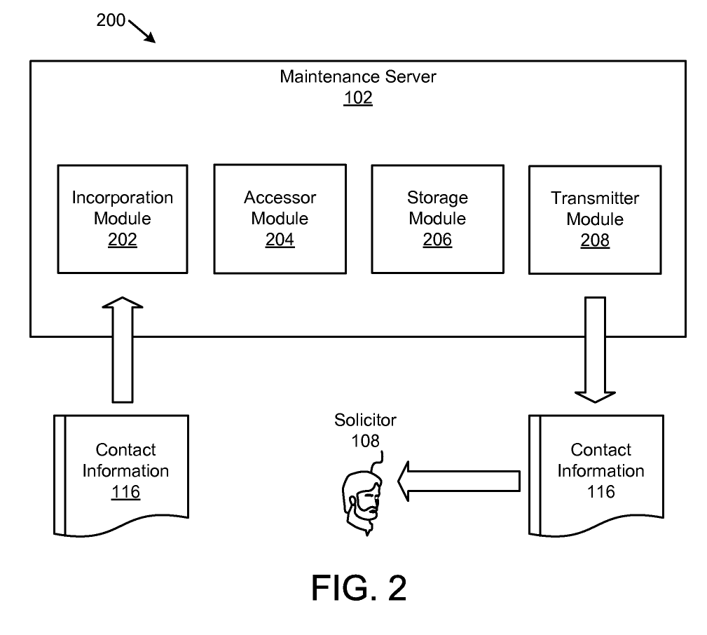

Referring now to FIG. 2, a schematic block diagram illustrating one embodiment of an apparatus 200 to automatically collect, solicit and remunerate MLM members in accordance with the present invention. The apparatus 200 includes an incorporation module 202, accessor module 204, storage module 206, and a transmitter module 208.

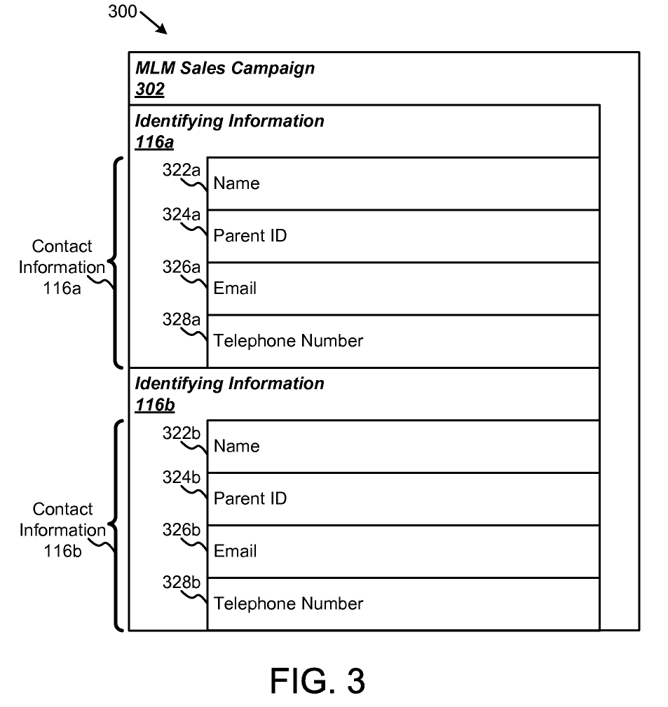

In the shown embodiment, the incorporation module 202 incorporates contacts 114a-c into the MLM structure 152, at which time they become customers 1 10 in the shown embodiment. The incorporation module 202 stores identifying information for the customer 110 in a computer readable file to which the maintenance server 102 and/or the MLM structure 152 have exclusive access (described below in relation to FIG. 3). In various embodiments, the incorporation module 202 creates a logical pay grade, or level, in which the incorporation module 202 registers, or recognizes, the customer 110 for later use in remuneration and MLM structuring purposes.

The apparatus 200 includes an accessor module 204 for accessing the contact information 116. The accessor module 202 may comprise the hardware, software and/or firmware necessary to read block storage or content-addressable storage as will be recognizable to those of skill in the art. The accessor module 204 accesses contact information 116 identifying contacts 114a-c, which contact information 116 and contacts 114a-c are substantially described above in relation to FIG. 1.

In the shown embodiment, the contact information 116 comprises a computer readable file written in computer readable storage after being accessed by accessor module 204. More detail on the computer readable file is shown and described below in relation to FIG. 3.

The storage module 206 stores the contact information 116 in persistent storage to which the maintenance server 102 has exclusive access. The storage module 206 may comprise a peripheral device which is internal or external to the maintenance server 102, such as a disk-drive.

The transmitter module 208 is configured to transmit the contact information 116 from the storage module 206 to the solicitor 108 through means well-known to those of skill in the art.

In certain embodiments, the apparatus 200 includes a remuneration module for automatically collecting funds from customers 110 and remunerating commissions to other customers 110 within the MLM structure 152 in accordance with the wishes of a predetermined MLM structure 152 substantially described above in relation to FIG. 1.

In still further embodiments, the apparatus 200 comprises a communication module to communicate sales information to customers 110 and/or solicitors 108. The communication module, in this embodiment, comprises the hardware, software and/or firmware necessary to effectuate the communication. The communication module may also direct contacts 114 to websites hosted by the maintenance server 102 and to unique landing pages automatically customized for the contact 114 visiting using the contact information 116. A unique tracking link emailed to the contact 114 by the communication module may effectuate this direction. The landing page may welcome the contact 114 by name, and display products or offers to the contact 114 determined from analyzing the buying preferences or demographic information of other contacts and/or customers 110 associated with the contact 114.

The landing page may prompt the contact 114 to permit access to contact information 116 in the possession of the contact 114 after the contact 114 is incorporated as a customer 110. The communication module may then access, or grab, contact information 116 from the customer using means known to those skill in the art. In still other embodiments, the landing page may prompt the customer 110 to manually enter the contact information 116 into the landing page for relay to storage module 206.

Referring now to FIG. 3, a computer readable file 300, accessible by a computer program product, storable on a tangible medium for recording contact information 116. FIG. 3 depicts one embodiment of a sales campaign 302, the sales campaign 302 comprising contact information 116a-b, the contact information 116a-b comprising a name 322, a parent ID 324, an email 326, and a telephone number 328.

The sales campaign 302 may comprise all contact information 116a-b collected over a predefined or undefined period of time by the accessor module 204 or only contact information 116a-b that satisfies a predetermined distribution criteria, such as contact information 116a-b scheduled to be routed to a particular solicitor 108.

The sales campaign 302, in the shown embodiment, comprises a database record identifying one or more contacts 114. The sales campaign 302 preferably comprises a structured computer-readable file, but may also comprise a book, audio recording, video, digital image, or the like. The sales campaign 302 may comprise a relational computer database managed by a relational database management system (RDBMS) or a database management system (DBMS), such as Oracle, DB2, Firebird, SQL, or other DBMSs as well-known to those of skill in the art.

In this embodiment, the contact information 116a-b comprises parent IDs 324a-b. The parent IDs 324a-b comprise unique indentifiers which specify the customer 110, or incorporated MLM member, who is responsible for supplying the contact information 116a-b of which the parent IDs 324a-b form part. The parent IDs 324a-b in the sales campaign 302 and the contact information 116a-b, may be used by the remuneration module and the MLM structure 152 to identify MLM pay grades, or levels, and to calculate commissions in accordance with the predetermined MLM criteria. The contact 114 identified in the contact information 116a-c becomes a “child” of the contact 110 identified in a particular parent ID 324. B-tree graphs may be generated showing parent and child contacts 110 using the parent IDs 324a-b.

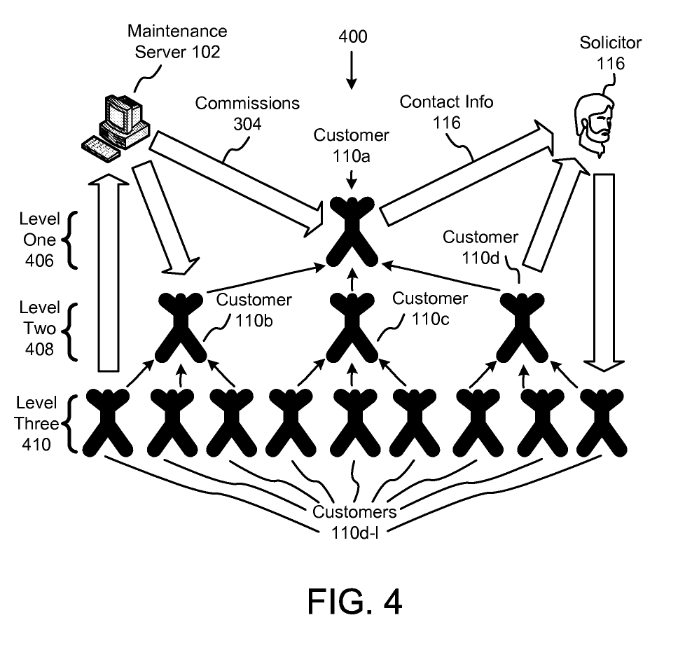

FIG. 4 is a block diagram illustrating another embodiment of an MLM structure in accordance with the present invention. FIG. 4 highlights the pay grades, or levels, that exist in various embodiments of the MLM structure 152. The MLM structure 152 illustrated in FIG. 4 comprises a maintenance server 102, a solicitor 116, commissions 304, contact information 116, customers 110a-1, and three pay grades, or levels, level one 406, level two 408, and level three 409.

In the shown embodiment, customer 110a, also an incorporated MLM member, is in the highest pay grade, level one 406. Customer 110a is responsible, directly or indirectly, for the incorporation of customers 110b-1 and hence, is remunerated for revenue generated on the sale of consumer product 106 realized by customers 110b-1 or their contacts 114, regardless of whether those customers are in level two 408, level three 410, or subsequent level added as the MLM structure 152 grows.

In the shown embodiment, customer 110b is responsible for the incorporation of customers 110d-f, and sits in level two 408. Customer 110b receives commissions 304 only for sales of consumer product 106 realized by customers 110d-f in level three 410, and contacts 114 of customers 110d-f whom customers 110d-f later incorporate.

The maintenance server 102, in the shown embodiment, collects sales revenue directly from customers 110d-l and distributes commissions 304 based on the sales revenue to the MLM members in level one 406, and level two 408. As the MLM structure grows, customers 110d-1 are likewise remunerated for sales effectuated by new levels, or pay grades, logically created and populated within computer readable storage on the maintenance server 102.

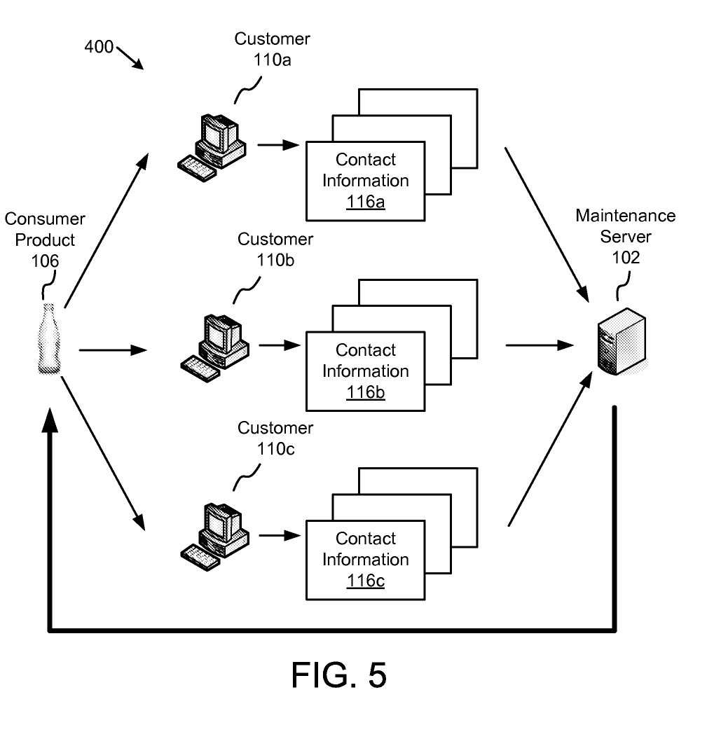

Referring now to FIG. 5, a block diagram illustrating another embodiment of a computer system 500 that automatically collects, solicits and remunerates members of a MLM structure in accordance with the present invention. The system 500 includes a consumer product 106, customers 110a-c, a plurality of contact information 116a-c, and a maintenance server 102.

In the shown embodiment, a consumer product 106 originating with the maintenance server 102 is distributed free of charge to customers 110a-c. The customers 110a-c accept this free product 106 in exchange for transmitting, or providing access to, contact information 116a-c to which the maintenance server 102 would not have access without the customer's 110a-c permission. In this embodiment, the contact information 116a-c is replicated and stored in persistent storage external to the maintenance server 102 within a computer readable database formatted as shown above in relation to FIG. 3.

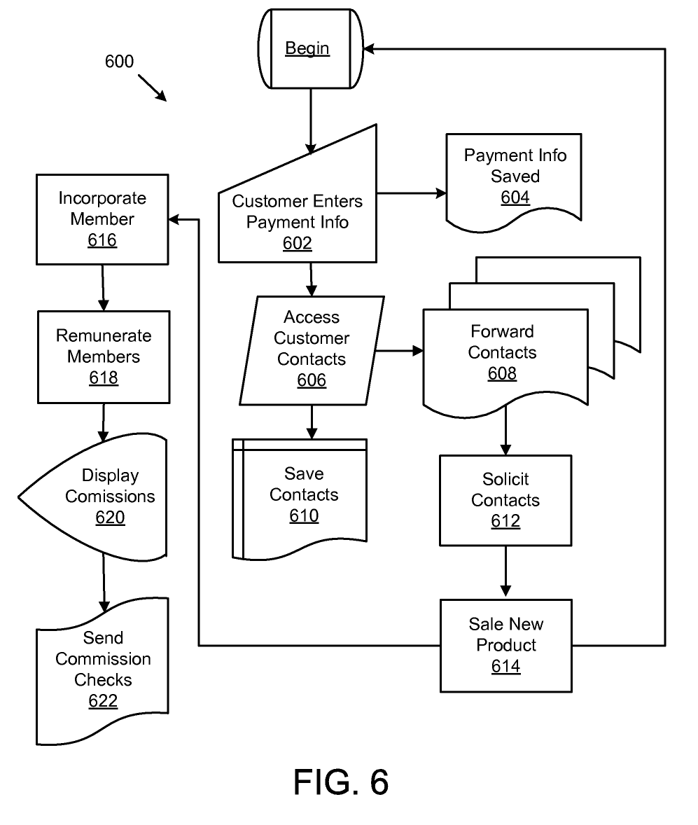

FIG. 6 is a data flow chart of a means for collecting, soliciting and remunerating members of a MLM structure 152 in accordance with the present invention. FIG. 6 illustrates one embodiment of a method of processing data by an MLM structures in accordance with the present invention. Among the functions and processes shown, FIG. 6 illustrates that certain automated, or non-automated, functions of the MLM structure may be performed concurrently, or non-sequentially. For instance, after a customer 110 enters payment information 602 for a consumer product 106, the payment information 110 is stored and customer contacts 114 are accessed 606 simultaneously. Likewise, after customer contacts 114 are accessed, the MLM structure may forward those contacts 608 to one or more solicitors 108 while simultaneously saving the contacts 114 on computer readable storage coupled to the maintenance server 102.

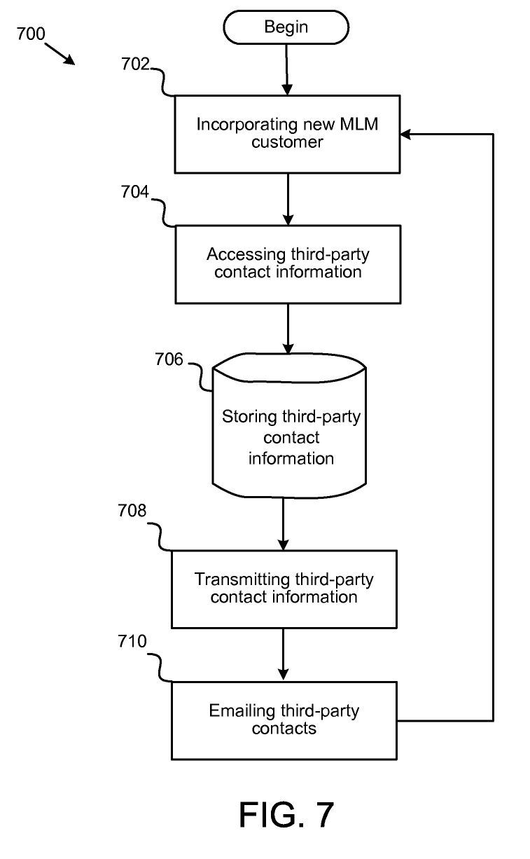

Referring now to FIG. 7, a method 700. FIG. 7 is a flow chart of a method of automatically collecting, soliciting and remunerating members of a MLM structure in accordance with one embodiment of the present invention. The method 700 substantially includes the embodiments and modules described above with regard to the apparatus, computer program product, and system depicted in FIGS. 1-6.

The method 700 begins and a new customer 110 is incorporated 702 into the MLM structure. The customer 110 may have been a contact 114 of another customer 110, or may be an individual or organization solicited by the solicitor 108 through other means substantially described above in relation to FIGS. 1-6. In the preferred embodiment, the incorporation 702 takes place when the customer 110 agrees to receive a free consumer product 106 in exchange for providing contact information 116.

The method 700 progresses and the accessor module 204 accesses 704 third-party contact information 116 in the possession of the customer 110 to which the accessor module 204 would not have access without customer's 110 permission.

Next, this contact information 116 is stored 706 in persistent storage on a maintenance server 102 where it can be eventually or immediately transmitted to 708, or accessed by, a solicitor 108.

Finally, the solicitor 108 automatically solicits the contacts 114 identified in the contact information 116. Those contacts 114 whom are successfully solicited by the solicitor 108 are incorporated into the MLM structure 152 and the method 700 begins again 702.

In alternate embodiments, the method 700 includes remuneration step in which a customer 110, or member of the MLM structure, is automatically remunerated by the remuneration module.

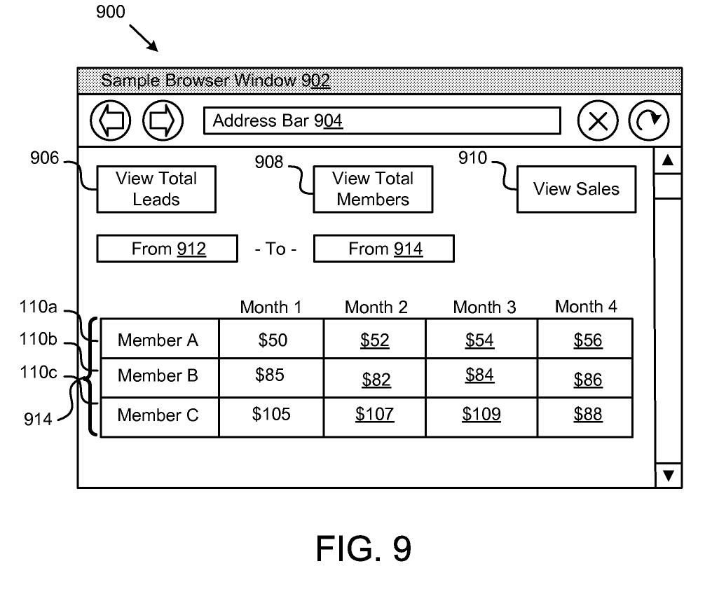

Referring now to FIG. 9, a user screen 900 showing sales commissions displayed in a computer environment by a maintenance server. FIG. 9 is a user screen in a generic web browser showing the operations of a computer program product embodiment of the present invention. The user screen 900 includes a sample web browser window 902 comprising an address bar 904, a view total leads button 506, a view total members button 508, a view sales button 510, a date range comprising a ‘from’ field 912 and a ‘to’ field 914, and a commissions report 914 comprising rows representing customers 110a-c and columns month 1, month 2, month 3, and month 4.

The operations of the computer program product shown on the sample browser window 902 on a graphic user interface (GUI) in one embodiment. The sample browser window 902 displays commission reports 914 relating to customers 110a-c. The commission reports 914 comprise information collecting over period of time defined in the from field 912 and to field 914 (hereinafter the “defined period”). The commission reports 914 may comprises total commissions earned by customers 110a-c over the defined period, or they may comprises the commissions 304 earned by an MLM member on sales effectuated by customers 110a-c. In the shown embodiment, the sample browser 902 is showing a commission report 914 for an MLM member logged into a secure account on the maintenance server 102 over the Internet 104. The sample browser window 902 is displaying commission reports 914 comprising commissions 304 earned on the sales of MLM members whom were incorporated by the MLM member logged into the maintenance server 102. The maintenance server 102 transmits the cost information to the sample browser window 902 via the Internet 104 to help MLM members track commission information by viewing commission reports 914. In some embodiments of the present invention, the MLM member logged into the maintenance server 102 may create a predetermined commission criteria which applies to the entire MLM structure 152 based on information viewed in the commission reports 914. In other embodiments, the MLM member logged into the maintenance server 102 may create a predetermined commission

A web browser, such as the sample browser window 902, is a well-known to those of skill in the art. A web browser is a software application that displays and interacts with human beings using text, video, audio, and the like, usually received over the Internet 104 or a LAN. Examples of web browsers include Internet Explorer, Mozilla Firefox, Google Chrome, Safari and the like. Web browsers typically communicate using hyper-text transfer protocol (HTTP), but may communicate in other protocols well-known to those of skill in the art. The sample browser window 902, in this embodiment, contains several functional and non-functional elements described below. The sample browser window 902, in some embodiments, is populated by a display module within an apparatus embodiment of the present invention.

Included in the sample browser window 902 is an address bar 904. The address bar 904 indicates the uniform resource locator (URL) with which the sample web browser 902 is communicating.

Included in the sample browser window 902 is a view total leads button 906, which changes the sales report 914 to show the total leads 116 collected from customers 110a-c respectively.

Included in the sample browser window 902 is a view sales lead button 508, which changes the grid 514 to show the costs associated with the sales leads 104.

Included in the sample browser window 902 is a view sales button 910, which changes the commission reports 914 to show total sales associated with each respective customer 110a-c rather than the commissions 304 garnered for a particular MLM member from the sales.

In alternative embodiments, other buttons might be included in the sample browser window 902, such as buttons enabling the display of costs associated with a particular sales campaign 302, associated with consumer product(s) 106, or only customers 110a-c located in a certain geographic area, and the like.

In the shown embodiments, the commission report 914 comprises commission information related to customers 110a-c. In other embodiments of the present, the commission report 914 comprises information related to sales campaigns 302, different predetermined commission criteria, different sales products, and the like.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer program product comprising a computer readable medium having: computer usable program code executable to perform operations for automatically collecting, soliciting and remunerating members of an MLM structure, the operations of the computer program product comprising:
incorporating a customer into an MLM structure by storing one or more of the customer's name, email, address, and phone number in persistent computer readable storage;
electronically accessing identifying information of one or more third-party contacts (hereinafter the “contact information”) in possession of the customer via a computer network, said contact information accessible only through a grant of permission of from the customer, said contact information structured in one or more computer readable files and comprising one or more of name, address, email, telephone number, employer, and profession;
replicating the contact information on a tangible medium after electronically accessing the third-party contact information;
transmitting the contact information to one or more solicitors; and
using an MLM identifier to track the customer with whom the contact information originated.

2. The computer program product of claim 1, further comprising remunerating the customer for sales realized from the third-party contacts associated with the customer.

3. The computer program product of claim 2, wherein the customer is remunerated in accordance with a predetermined commission criteria.

4. The computer program product of claim 1, further comprising emailing the third-party contacts with MLM promotional information.

5. The computer program product of claim 1, further comprising automatically incorporating the third-party contacts into the MLM structure.

6. The computer program product of claim 4, further comprising notifying the customer that the one or more third-party contacts have been incorporated into the MLM structure.

7. The computer program product of claim 1, wherein the contact information comprises a computer database entry stored in one or more computer readable files on a computer readable storage device in communication with a maintenance server.

8. The computer program product of claim 7, where in the maintenance server allows the third-party contacts to place orders for a consumer product online via the Internet.

9. An apparatus configured to manage to automatically collect, solicit and remunerate members of an MLM structure, the apparatus comprising:
A database server comprising a processor and a memory device, the database server configured to store executable and operational data, the memory device comprising:
an incorporation module configured to incorporate a customer into an MLM structure by storing one or more of the customer's name, email, address, and phone number in persistent computer readable storage;
an accessing module configured to electronically access identifying information of one or more third-party contacts (hereinafter the “contact information”) in possession of the customer via a computer network, said contact information accessible only through a grant of permission of from the customer, said contact information structured in one or more computer readable files and comprising one or more of name, address, email, telephone number, employer, and profession;
a storage module configured to replicated and store the contact information on a tangible medium after electronically accessing the third-party contact information;
a transmission module configured to transmit the contact information to one or more solicitors; and
a tracking module configured to use an MLM identifier to track the customer with whom the contact information originated.

10. The apparatus of claim 9, further comprising a remuneration module configured to remunerate the customer for sales realized from the third-party contacts.

11. The apparatus of claim 10, wherein the remuneration module remunerates in accordance with a predetermined commission criteria.

12. The apparatus of claim 9, further comprising a communication module configured to do one or more of: email the third-party contacts with MLM promotional information, and direct the customer to a webpage customized for the customer.

13. The apparatus of claim 9, wherein the incorporation module automatically incorporates the third-party contacts into the MLM structure.

14. The apparatus of claim 9, further comprising a notification module configured to notify the customer that the one or more third-party contacts have been incorporated into the MLM structure.

15. The apparatus of claim 9, wherein the contact information comprises a computer database entry stored in one or more computer readable files on a computer readable storage device in communication with a maintenance server.

16. A system to automatically collect, solicit and remunerate members of an MLM structure, the system comprising:
an incorporation module configured to incorporate, by way a computer program product, a customer into an MLM structure by storing one or more of the customer's name, email, address, and phone number in persistent computer readable storage;
an accessor module configured to electronically access, by way a computer program product, identifying information of one or more third-party contacts (hereinafter the “contact information”) in possession of the customer via a computer network, said contact information accessible only through a grant of permission of from the customer, said contact information structured in one or more computer readable files and comprising one or more of name, address, email, telephone number, employer, and profession;
a storage module configured to replicate, by way a computer program product, the contact information on a tangible medium after electronically accessing the third-party contact information;
a transmitter module configured to transmit, by way a computer program product, the contact information to one or more solicitors; and
a tracking module configured to use an MLM identifier to track, by way a computer program product, the customer with whom the contact information originated.

17. The system of claim 16, further comprising a remuneration module configured to remunerate, by way a computer program product, the customer for sales realized from the third-party contacts.

18. The system of claim 17, wherein the remuneration module remunerates the customer in accordance with a predetermined commission criteria.

19. The system of claim 16, further comprising a communication module configured to email, by way a computer program product, the third-party contacts with MLM promotional information.

20. The system of claim 16, wherein the incorporation module is further configured to automatically incorporate, by way a computer program product, the third-party contacts into the MLM structure.

21. A method of collecting, soliciting and remunerating members of an MLM structure, the steps of the method comprising:
incorporating a customer into an MLM structure by storing one or more of the customer's name, email, address, and phone number on a tangible storage medium;
accessing identifying information of one or more third-party contacts (hereinafter the “contact information”) in possession of the customer via a computer network, said contact information accessible only through a grant of permission of from the customer, said contact information comprising one or more of name, address, email, telephone number, employer, and profession;
replicating the contact information on a tangible medium after electronically accessing the third-party contact information;
transmitting the contact information to one or more solicitors; and
using an MLM identifier to track the customer with whom the contact information originated.

22. The method of claim 21, further comprising remunerating the customer for sales realized from the third-party contacts associated with the customer.

23. The method of claim 22, wherein the customer is remunerated in accordance with a predetermined commission criteria.

24. The method of claim 23, wherein the MLM structure comprises a plurality of predetermined commission criteria established for imposition on MLM members beneath one or more predetermined MLM paygrades.

25. The method of claim 24, further comprising generating commission reports specific to each pay grade of the MLM structure.

26. The method of claim 23, further comprising mailing the third-party contacts with MLM promotional information.

27. The method of claim 21, further comprising incorporating the third-party contacts into the MLM structure.

28. The method of claim 27, further comprising notifying the customer that the one or more third-party contacts have been incorporated into the MLM structure.

29. The method of claim 21, wherein the contact information comprises a computer database entry stored in one or more computer readable files on a computer readable storage device in communication with a maintenance server.

30. The method of claim 29, where in the maintenance server allows the third-party contacts to place orders for a consumer product online via the Internet.
